(19) United States
(12) Patent Application Publication
(10) Pub. No.: US 2012/0098886 A1
(43) Pub. Date: Apr. 26, 2012

(54) PRINT HEAD MAINTENANCE SYSTEM

(75) Inventors: Vesa Karppinen, Balmain (AU); Yazhuo Li, Balmain (AU); David William Jensen, Balmain (AU)

(73) Assignee: Silverbrook Research Pty Ltd.

(21) Appl. No.: 12/910,865

(22) Filed: Oct. 25, 2010

(51) Int. Cl. B41J 2/165

(52) U.S. Cl. 347/30

(57) ABSTRACT

A print head maintenance system for maintaining a stationary print head is disclosed. The maintenance includes both cleaning and priming In one embodiment the system includes a suction nozzle, a pump for supplying suction to the suction nozzle, and a positioning mechanism for moving the suction nozzle longitudinally past the print head. In an alternative embodiment the system further includes an ejection nozzle closely spaced to the suction nozzle, and a further pump for supplying fluid to the ejection nozzle. The positioning mechanism moves the ejection and suction nozzles longitudinally past the print head.

### FIELD OF THE INVENTION

The present invention relates generally to ink-jet printing and, in particular, to a system for maintaining a full-width array ink-jet print head.

### BACKGROUND

A print head of an ink-jet printer typically contains thousands of very small closely arranged nozzles. The diameter of a typical nozzle opening is in the order of 15 μm. The print head is in close contact with a substrate, such as a sheet of paper, being printed on. Debris on the substrate, such as lint or stray paper fibers, is often picked up by the print head, causing such debris to block some of the nozzles thereby preventing proper operation.

Another cause for nozzles to cease proper operation is when the ink in the nozzles dries. Drying ink causes the pigments and dyes to dry out, thereby forming a viscous mass, or even a solid mass, that blocks the ink passageways and nozzles. Ink drying may affect the print head as a whole, for example when the entire print head has not been used for some time, or may also affect individual nozzles when such nozzles have not ejected ink for some time.

Failure of even a single nozzle may cause a visible effect on the printed output by the print head. The effect is typically a blank line across the printed output. Proper cleaning of the print head is therefore essential to providing a quality printed output from a print head.

To improve the reliability of print heads, most printers include a “maintenance station”. The maintenance station typically includes a flexible blade. Typically the print head slides into the maintenance station, and contacts the flexible blade which is arranged to wipe any contaminants off the front face of the print head. When nozzles are clogged, the printer attempts to fire all nozzles at once. Some of the ink generally wicks across the print head. The flexible blade is wiped across the print head to spread the ink evenly across the print head, thereby covering nozzles containing dried ink. The dried ink in those nozzles is rehydrated by the ink swept across the print head, and the nozzles are again all fired to dislodge any ink clumps blocking the nozzles.

However, wiping the flexible blade across the print head may force some of the contaminants on the face of the print head into the nozzles, thereby blocking the nozzles.

A need exists for an improved maintenance mechanism for cleaning print heads, while also providing a mechanism for rehydrating the print head.

### SUMMARY

It is an object of the present invention to substantially overcome, or at least ameliorate, one or more disadvantages of existing arrangements.

According to an aspect of the present disclosure, there is provided a system for maintaining a stationary print head, the system comprising:

a suction nozzle;

a pump for supplying a below atmospheric pressure to the suction nozzle; and

a positioning mechanism for moving the suction nozzle longitudinally past the print head.

Preferably the system further comprises:

an ejection nozzle closely spaced to the suction nozzle; and

a further pump for supplying fluid to the ejection nozzle, wherein the positioning mechanism moves the ejection and suction nozzles longitudinally past the print head.

Preferably the fluid is ink.

Preferably the system further comprises a reservoir from which the fluid is pumped by the further pump, wherein fluid sucked from the print head by the suction nozzle is returned to the reservoir.

Preferably the system further comprises means for maintaining a constant distance between the suction nozzle during longitudinal movement of the suction nozzles past the print head.

Preferably the means for maintaining the constant distance is a wheel associated with the suction nozzle, the wheel contacting the print head during longitudinal movement.

Other aspects of the invention are also disclosed.

### BRIEF DESCRIPTION OF THE DRAWINGS

One or more embodiments of the present invention will now be described with reference to the drawings, in which:

FIG. 1 illustrates the principle of operation of a print head maintenance system according to the present invention;

FIGS. 2 and 3 illustrate two alternative fluid supply and return arrangements of the print head maintenance system;

FIG. 4 illustrates the motion of a nozzle arrangement of the print head maintenance system relative to a print head being maintained;

FIG. 5 shows a head portion of the print head maintenance system;

FIG. 6 shows a slidable tray containing the print head maintenance system, a capper and a platen where the platen is underneath the print head;

FIG. 7 shows the slidable tray moved to a position where the capper is underneath the print head; and

FIG. 8 shows the slidable tray moved to a position where the print head maintenance system is underneath the print head.

### DETAILED DESCRIPTION INCLUDING BEST MODE

Where reference is made in any one or more of the accompanying drawings to features which have the same reference numerals, those features have for the purposes of this description the same function(s) or operation(s), unless the contrary intention appears.

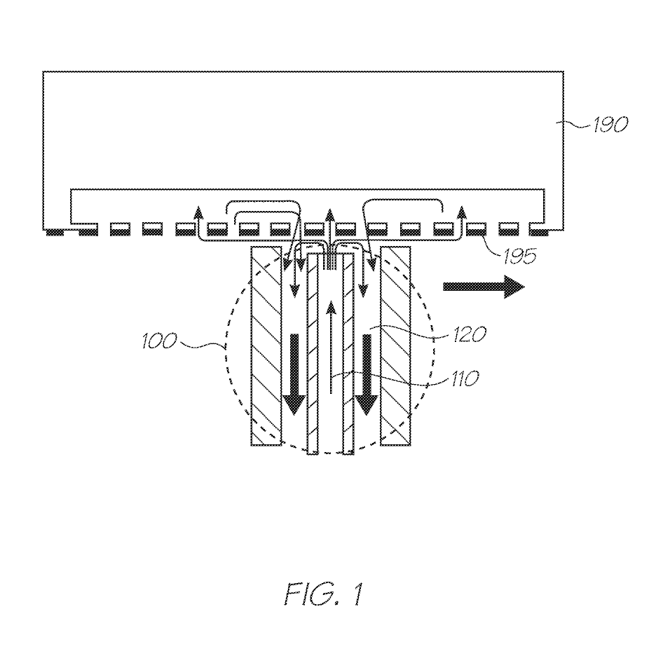

FIG. 1 illustrates the principle of operation of a print head maintenance system according to the present invention. The print head maintenance system includes a nozzle arrangement 100 having a fluid ejection nozzle 110 and a vacuum nozzle 120. The nozzles 110 and 120 are in close proximity to each other. In the preferred embodiment both the fluid ejection nozzle 110 and the vacuum nozzle 120 have circular cross-sections having diameters of 0.5 mm and 2 mm respectively. FIG. 1 illustrates a cross-sectional view of the nozzles 110 and 120. The nozzles 110 and 120 are preferably coaxial, with the fluid ejection nozzle 110 inside the vacuum nozzle 120. In an alternative embodiment the nozzles 110 and 120 have rectangular cross-sections (not illustrated), with the fluid ejection nozzle 110 flanked by two vacuum nozzles 120.

Also illustrated in FIG. 1 is a full-width array ink jet-print head 190 maintained by the print head maintenance system. The full-width array ink-jet print head 190, which extend across the width of a sheet (not illustrated), remains stationary during printing. The full-width array ink-jet print head 190 also remains stationary during priming and cleaning by the print head maintenance system. The downward facing surface of the ink-jet print head 190 has arrays of selectively-actuable ink nozzles 195.

The vacuum nozzle 120 sucks air, debris and fluid from the surface of the print head 190. The fluid ejection nozzle 110 ejects fluid onto the surface of the print head 190. Some of the fluid ejected by the fluid ejection nozzle 110 penetrates the openings of the ink nozzles 195. The fluid sucked by the vacuum nozzle 120 includes that ejected by the fluid ejection nozzle 110 and a small amount of ink from the ink nozzles 195. In the preferred embodiment the fluid ejected by the fluid ejection nozzle 110 is ink.

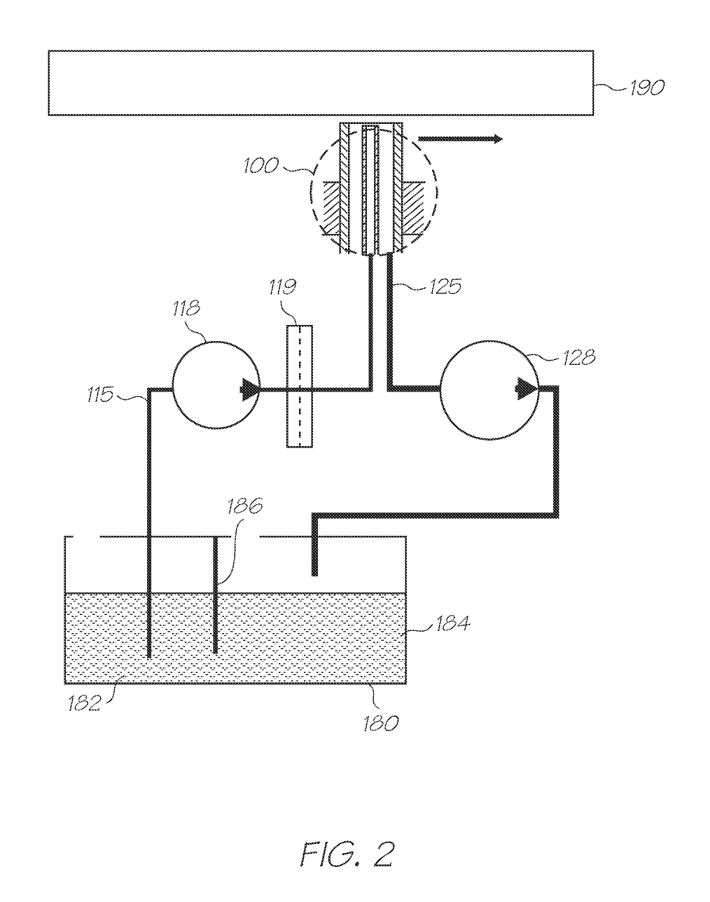

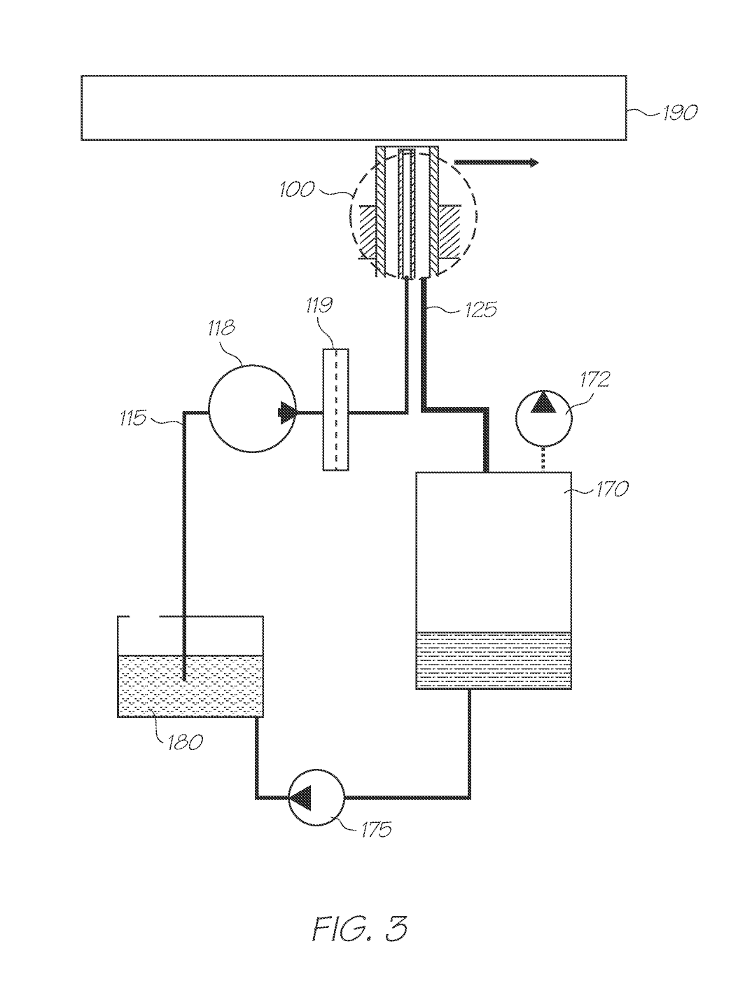

FIGS. 2 and 3 illustrate two alternative fluid supply and return arrangements. In both arrangements the fluid ejection nozzle 110 is supplied with fluid through a fluid supply tube 115. A positive displacement pump 118 in the flow path of the fluid supply tube 115 pumps fluid from a fluid tank 180, through a micro filter 119 and to the fluid ejection nozzle 110. In the preferred embodiment the rate of flow of the fluid supplied by the positive displacement pump 118 to the fluid ejection nozzle 110 is 3 to 15 ml/min, and the density of the micro filter 119 is 4 microns.

In the fluid supply and return arrangement illustrated in FIG. 2 a vacuum tube 125 supplies a vacuum to the vacuum nozzle 120. The vacuum is provided by a further positive displacement pump 128. The air, debris and fluid sucked from the surface of the print head 190 by the vacuum nozzle 120 are fed by the vacuum tube 125 to the fluid tank 180. In the preferred embodiment the rate of flow of the positive displacement pump 128 in the flow path of the vacuum tube 125 is 4 to 7 1/min at 500 mBar absolute. Fluid tank 180 is separated into a supply part 182 and a return part 184 by a baffle structure 186. The air, debris and fluid mixture returned by the vacuum tube 125 is returned to the return part 184 of the fluid tank 180 where air bubbles and foam are allowed to settle. The fluid supply tube 115 draws fluid from the supply part 182 of the fluid tank 180.

In the fluid supply and return arrangement illustrated in FIG. 3 the vacuum tube 125 directly connects the vacuum nozzle 120 to a settle tank 170. The settle tank 170 is provided with a vacuum pump 172 or other vacuum source, which causes a low pressure in the settling tank 170. The low pressure in the settling tank 170 causes the vacuum tube 125 to suck air, debris and fluid mixture from the vacuum nozzle 120 to a settle tank 170. A vane pump 175 is also provided which pumps fluid from the settling pump 170 to the fluid tank 180. The vane pump 175 prevents reverse flow during non-operational periods. Preferably the low pressure caused by the vacuum pump 170 is 400 to 500 mb (millibar) absolute.

In one embodiment the fluid in supply tube 115 is heated, for example by heating the fluid in fluid tank 180.

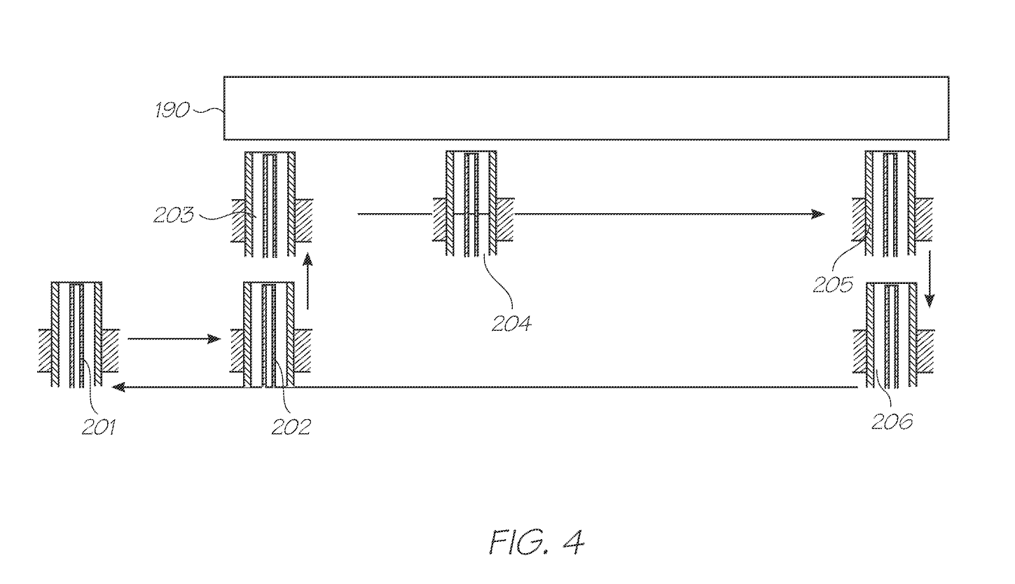

FIG. 4 illustrates the motion of the nozzle arrangement 100 relative to the print head 190 during operation. The tanks 170 and 180, filter 119 and pumps 118, 128 and 172 are preferably stationary, while flexible tubes 115 and 125 allows for the movement of the nozzle arrangement 100. In FIG. 4 the tanks 170 and 180, filter 119 and pumps 118, 128 and 172 are omitted for simplification of the illustration.

Initially the nozzle arrangement 100 is in a home position 201 distant from the print head 190. A maintenance cycle of the print head 190 starts with the nozzle arrangement 100 moving in a direction parallel to the longitudinal extent of the print head 190 until the nozzle arrangement 100 is directly below a longitudinal end of the print head 190, in position 202. The nozzle arrangement 100 is preferably 10 to 15 mm from the print head 190. Next, the nozzle arrangement 100 is moved towards the print head 190 to position 203. At position 203 both the pumps 118 and 128 are activated causing fluid to eject from fluid ejection nozzle 110 while vacuum nozzle 120 sucks air, fluid and debris.

The nozzle arrangement 100 is next moved along the print head 190, past position 204 until the opposite longitudinal end of the print head 190 is reached, at position 205. When the nozzle arrangement 100 reaches position 205 the pumps 118 and 128 are de-activated. In the preferred embodiment suction is maintained slightly longer than fluid ejection, for example 1 s longer. The nozzle arrangement 100 is then moved away from the print head 190 to position 206, before nozzle arrangement 100 is returned to the home position 201.

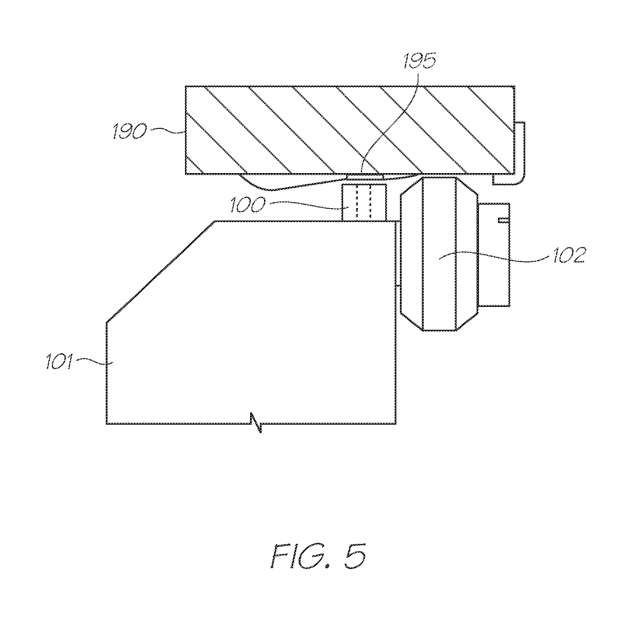

FIG. 5 shows a head portion 101 of the print head maintenance system. The head portion 101 includes the nozzle arrangement 100 and a wheel 102. Movement of the head portion 101 is spring loaded. Referring to FIG. 4, while the nozzle arrangement 100 is in positions 203 to 205, the wheel 102 contacts the print head 190 next to the ink nozzles 195 of the print head 190. The nozzle arrangement 100 is prevented from contacting the ink nozzles 195 of the print head 190 while maintaining a constant distance from the ink nozzles 195 by the wheel 102. The distance between the nozzle arrangement 100 and the print head 190 is preferably maintained at a distance of 100-150 μm. It would be understood by a person skilled in the art that, due to any irregularities in the surface upon which the wheel 102 rolls, there would be a slight variation in the constant distance between the nozzle arrangement 100 and the print head 190.

As an alternative to maintaining the entire print head 190, the print head maintenance system may be operated to maintain specific nozzles 195. In such a mode of operation the pumps 118 and 128 are activated when the head portion 101 is at a position 204 corresponding to blocked nozzles, after which the pumps 118 and 128 are de-activated.

Preferably the rate of flow of pumps 118 and 128 are separately controllable. The ratio fluid ejection versus vacuum is increased in order to rehydrate a dry print head 190, or to reprime the print head 190. This may be achieved by either increasing the rate of flow of fluid ejection pump 118, or by decreasing the rate of flow of pump 128 (FIG. 2) or pump 172 (FIG. 3).

Whereas the print head maintenance system is described above in a mode where the fluid ejection nozzle 110 ejects fluid while the vacuum nozzle 120 applies suction to the print head 190, the print head maintenance system may also be operated in a mode where only suction is applied by the vacuum nozzle 120. Accordingly, pump 118 is stationary, and no fluid is ejected from the fluid ejection nozzle 110. In this mode of operation the distance between the vacuum nozzle 120 and the print head 190 is preferably maintained at a distance of 30-80 μm by the wheel 102. The suction removes any debris and particles from the print head 190. The suction also sucks air bubbles from the nozzles and ducts feeding ink to the nozzles, thereby priming dry nozzles. Any ink sucked by the vacuum nozzle 120 is fed to the fluid tank 180.

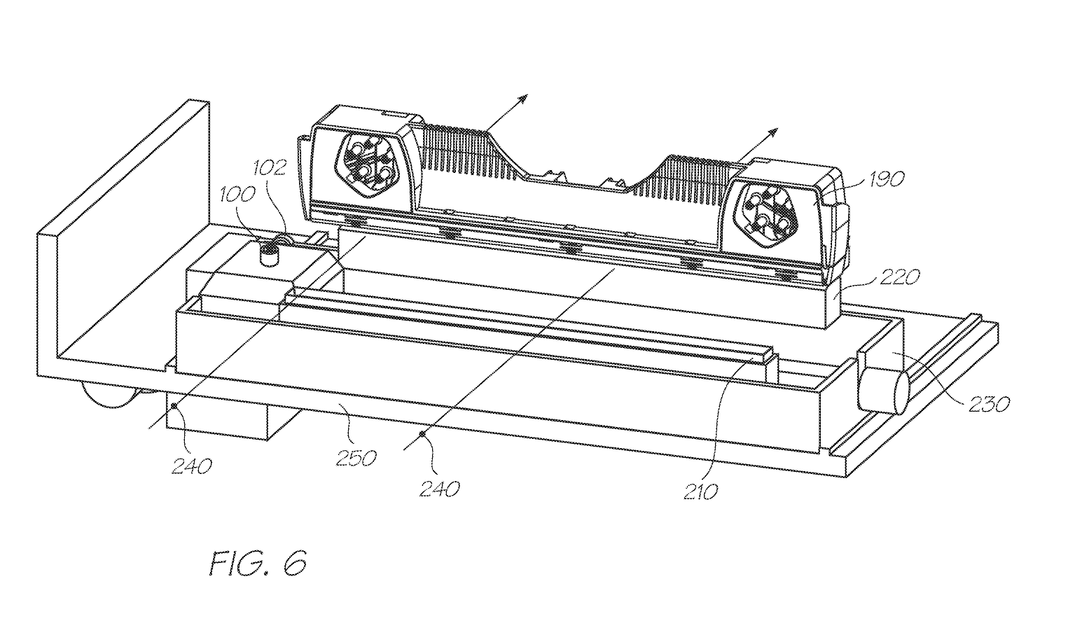

FIGS. 6 to 8 show the stationary print head 190 in a printing position, a capped position and a cleaning/rehydration position respectively. The head portion 101 of the print head cleaner, a capper 210 and a platen 220 are provided on a tray 230 slidable with respect to a printer frame 250.

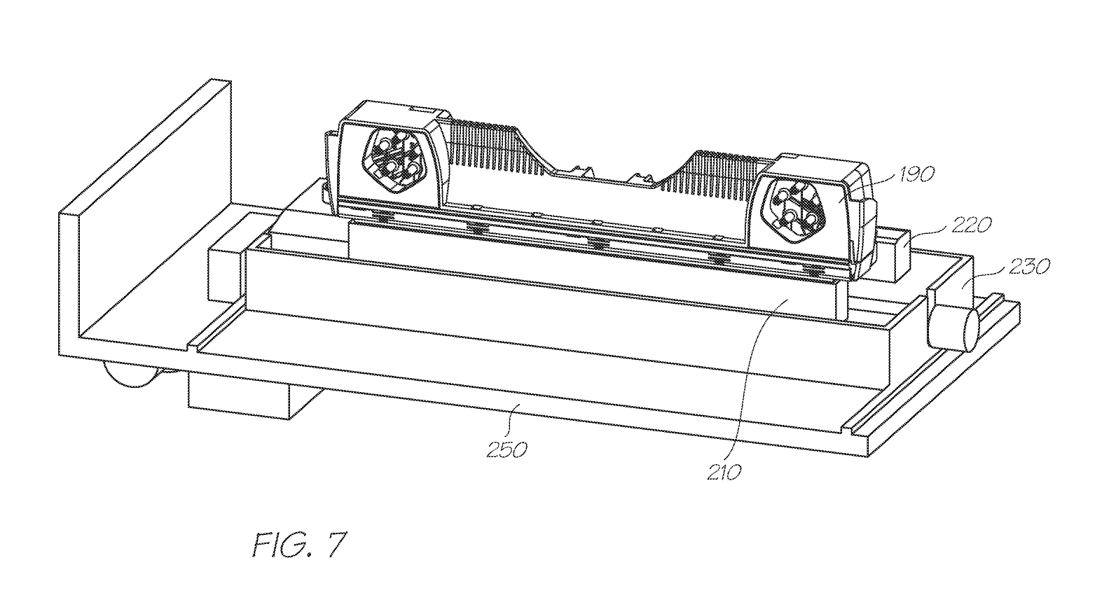

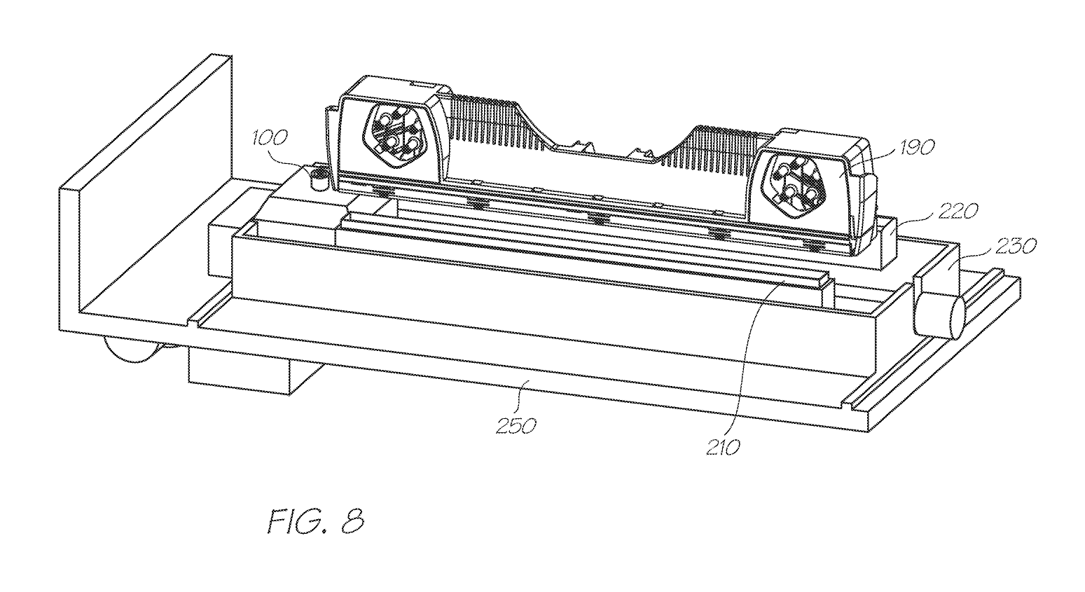

In FIG. 6 the slidable tray 230 is moved to a position where the platen 220 is underneath the print head 190. A sheet of paper (not illustrated) is moved through a paper feed path 240 which extends between the platen 220 and the print head 190. In FIG. 7 the slidable tray 130 is moved to a position where the capper 210 is underneath the print head 190. The capper 210 provides a seal over the ink nozzles 195 of the print head 190, thereby preventing the ink nozzles 195 from drying. In FIG. 8 the slidable tray 130 is moved to a position where the head portion 101 is underneath the print head 190. More particular, the head portion 101 is shown in position 204 (FIG. 4).

The printer frame 250 has a vertical actuation mechanism (not illustrated) which lifts one of the head portion 101, the capper 210 and the platen 220, positioned underneath the print head 190 towards the print head 190.

A main advantage provided by the print head maintenance system according to the present invention is that the maintenance is performed without any direct contact between the print head maintenance system and the print head being maintained. Prior art arrangements typically involve contact with the print head, which may force debris into nozzles.

While the invention has been described with reference to specific embodiments, it is evident that many alternatives, modifications, and variations will be apparent to those skilled in the art. Accordingly, it is intended to embrace all such alternatives, modifications, and variations which fall within the scope of the appended claims.

1. A system for maintaining a stationary print head, the system comprising:
a suction nozzle;
a pump in fluid communication with the suction nozzle for supplying a below atmospheric pressure to the suction nozzle; and
a positioning mechanism for moving the suction nozzle longitudinally past the print head.

2. A system according to claim 1 further comprising:
an ejection nozzle closely spaced to the suction nozzle; and
a further pump in fluid communication with the ejection nozzle for supplying fluid to the ejection nozzle, wherein the positioning mechanism moves the ejection and suction nozzles longitudinally past the print head.

3. A system according to claim 2 wherein the fluid is ink.

4. A system according to claim 2 further comprising a reservoir from which the fluid is pumped by the further pump, wherein fluid sucked from the print head by the suction nozzle is returned to the reservoir.

5. A system according to claim 1 further comprising means for maintaining a constant distance between the suction nozzle during longitudinal movement of the suction nozzles past the print head.

6. A system according to claim 5 wherein the means for maintaining the constant distance is a wheel associated with the suction nozzle, the wheel contacting the print head during longitudinal movement.
